(19) United States
(12) Patent Application Publication
(10) Pub. No.: US 2025/0378470 A1
(43) Pub. Date: Dec. 11, 2025

(54) INFORMATION PROCESSING APPARATUS, INFORMATION PROCESSING SYSTEM, METHOD, AND NON-TRANSITORY STORAGE MEDIUM

(71) Applicant: NEC Corporation, Tokyo (JP)

(72) Inventors: Hiroki UEOOTA, Tokyo (JP); Norihito OI, Tokyo (JP)

(73) Assignee: NEC Corporation, Tokyo (JP)

(21) Appl. No.: 19/213,172

(22) Filed: May 20, 2025

(30) Foreign Application Priority Data
Jun. 7, 2024 (JP) 2024-092737

(51) Int. Cl. G06Q 30/02

(52) U.S. Cl. CPC G06Q 30/0281

(57) ABSTRACT

A computer generates event information about an event performed in an amusement facility corresponding to information about a user of the amusement facility, and transmits the generated event information. The information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

### INCORPORATION BY REFERENCE

This application is based upon and claims the benefit of priority from Japanese patent application No. 2024-092737, filed on Jun. 7, 2024, the disclosure of which is incorporated herein in its entirety by reference.

### TECHNICAL FIELD

The present disclosure relates to an information processing apparatus, an information processing system, a method, and a non-transitory storage medium that provide information about an amusement facility.

### BACKGROUND ART

Technologies for providing various types of information about an amusement facility have been proposed. As an example of such technologies, Patent Literature 1 discloses an information providing system that provides information about a recommended route map used in a case where a user visits a plurality of attractions provided in a theme park one by one.
[Patent Literature 1] Japanese Unexamined Patent Application Publication No. 2017-182645

### SUMMARY

However, the information providing system disclosed in Patent Literature 1 has a problem that information about an event performed in an amusement facility cannot be generated based on information about a user of the amusement facility.

In view of the above-described problem, one of the objects of the present disclosure is to provide an information processing apparatus, an information processing system, a method, and a program by which information about an event performed in an amusement facility can be generated based on information about a user of the amusement facility.

An information processing apparatus configured to provide information about an amusement facility according to the present disclosure includes:
an event generation unit configured to generate event information about an event performed in the amusement facility, the event corresponding to information about a user of the amusement facility; and
a transmission unit configured to transmit the event information generated by the event generation unit,
in which the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

An information processing system according to the present disclosure includes:
a terminal apparatus used by a user of an amusement facility; and
an information processing apparatus configured to provide information about the amusement facility, in which
the terminal apparatus includes:
   a transmission unit configured to transmit information about the user of the amusement facility to the information processing apparatus; and
   an output unit configured to output information transmitted by the information processing apparatus,
the information processing apparatus includes:
   an event generation unit configured to generate event information about an event performed in the amusement facility, the event corresponding to the information about the user of the amusement facility; and
   a transmission unit configured to transmit the event information generated by the event generation unit to the terminal apparatus, and
the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

In a method according to the present disclosure,
a computer generates event information about an event performed in an amusement facility, the event corresponding to information about a user of the amusement facility,
the computer transmits the generated event information, and
the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

A non-transitory storage medium storing a program according to the present disclosure is provided. The program causes a computer to:
generate event information about an event performed in an amusement facility, the event corresponding to information about a user of the amusement facility; and
transmit the generated event information,
wherein the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

According to the present disclosure, it is possible to provide an information processing apparatus, an information processing system, a method, and a non-transitory storage medium by which information about an event performed in an amusement facility can be generated based on information about a user of the amusement facility.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram showing an example of an information processing system according to the present disclosure;

FIG. 2 is a diagram showing an example of a configuration of an information processing apparatus according to the present disclosure;

FIG. 3 is a diagram showing an example of a configuration of a user terminal apparatus according to the present disclosure;

FIG. 4 is a diagram showing an example of a user information table according to the present disclosure;

FIG. 5 is a flowchart showing an example of processes executed in the information processing system according to the present disclosure;

FIG. 6 is a flowchart showing another example of processes executed in the information processing system according to the present disclosure;

FIG. 7 is a diagram showing main components included in the information processing apparatus according to the present disclosure;

FIG. 8 is a diagram showing an example of a questionnaire related to event information; and

FIG. 9 is a diagram showing an example of an image including event information and map information.

### EXAMPLE EMBODIMENT

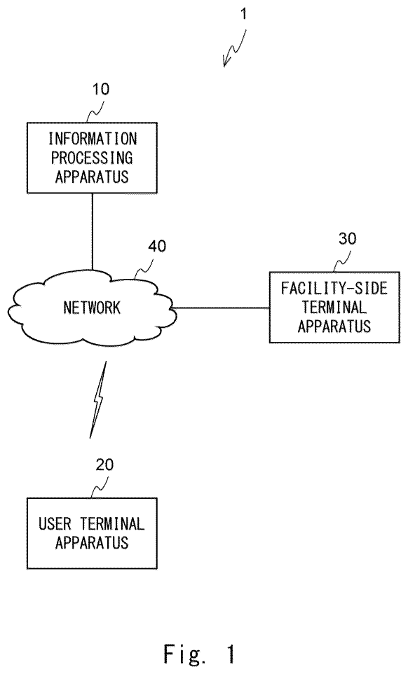

One illustrative example embodiment of the present disclosure will be described hereinafter with reference to the drawings. FIG. 1 is a diagram showing an example of an information processing system 1 according to the present disclosure. The information processing system 1 includes an information processing apparatus 10, a user terminal apparatus 20, and a facility-side terminal apparatus 30. Note that although one user terminal apparatus 20 and one facility-side terminal apparatus 30 are shown in FIG. 1, the information processing system 1 may include a plurality of the user terminal apparatuses 20 and the facility-side terminal apparatuses 30.

The information processing apparatus 10 communicates data with the user terminal apparatus 20 and the facility-side terminal apparatus 30 through a network 40. The network 40 may include a wide area network such as the Internet and a narrow area network such as a Local Area Network (LAN).

The information processing apparatus 10 is an apparatus that provides information about an amusement facility. Specific examples of the information processing apparatus 10 include an information processing apparatus such as a server. Details of a configuration of the information processing apparatus 10 will be described later.

The user terminal apparatus 20 is an information processing apparatus used by a user of an amusement facility. Specific examples of the user terminal apparatus 20 include, for example, a smartphone and a wearable terminal. Details of a configuration of the user terminal apparatus 20 will be described later.

The facility-side terminal apparatus 30 is an information processing apparatus managed by an amusement facility. Specific examples of the facility-side terminal apparatus 30 include, for example, a Point Of Sales (POS) terminal apparatus. The facility-side terminal apparatus 30 can display information provided from the information processing apparatus 10 on a display unit of the facility-side terminal apparatus 30 or on a display apparatus with which the facility-side terminal apparatus 30 can communicate.

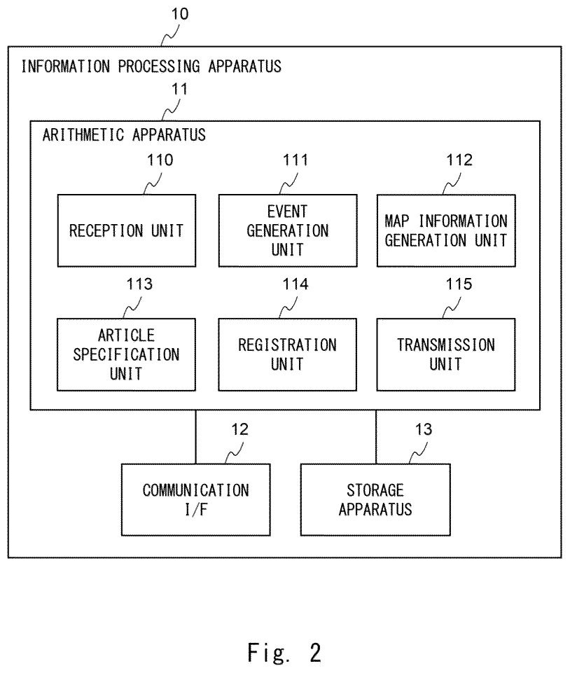

FIG. 2 is a schematic diagram showing the configuration of the information processing apparatus 10 according to the present disclosure. The information processing apparatus 10 includes an arithmetic apparatus 11, a communication interface (I/F) 12, and a storage apparatus 13.

The arithmetic apparatus 11 is an apparatus that performs overall control of the information processing apparatus 10. Specific examples of the arithmetic apparatus 11 include a processor such as a Central Processing Unit (CPU), a Graphics Processing Unit (GPU), and a Micro Processing Unit (MPU). The arithmetic apparatus 11 loads a program stored in the storage apparatus 13 into a memory and executes instructions included in the loaded program. Note that, in another example embodiment, functions executed by the arithmetic apparatus 11 may also be executed by an integrated circuit such as a Field-Programmable Gate Array (FPGA) or an Application Specific Integrated Circuit (ASIC). Each of these apparatuses corresponds to a computer.

The communication interface 12 is an interface for performing data communication between the information processing apparatus 10 and another apparatus. The storage apparatus 13 is a storage device in which various type of data such as a program executed by the arithmetic apparatus 11 and data processed by the arithmetic apparatus 11 are stored.

The arithmetic apparatus 11 includes a reception unit 110, an event generation unit 111, a map information generation unit 112, an article specification unit 113, a registration unit 114, and a transmission unit 115. These functions may be implemented by a program.

The reception unit 110 receives various types of information from the user terminal apparatus 20 and the facility-side terminal apparatus 30.

The event generation unit 111 generates event information, which is information about an event and corresponds to information required to generate an event performed in an amusement facility. Various types of information required to generate an event include information about a user of the amusement facility, the weather of the day on which the user uses the amusement facility, and the date on which the user uses the amusement facility. The event generation unit 111 generates event information corresponding to at least one of these pieces of information.

The information about the user of the amusement facility includes at least one of information indicating an article of a character related to the amusement facility, information about a character or a living creature which the user of the amusement facility likes, a time period during which the user is scheduled to stay in the amusement facility, how the user spend time in the amusement facility, information about an attraction used by the user in the amusement facility, profile information of the user, and a history of visits made by the user to the amusement facility.

Examples of the article of a character include a headband with character ears that can be worn by the user. Specific examples of how the user spend time in the amusement facility include, for example, a case in which the user spend time using attractions or a case in which the user spend time taking a walk in the amusement facility while using only some attractions.

Examples of the information about an attraction used by the user in the amusement facility include information indicating that the user uses a ride with a certain running speed, such as a roller coaster, installed in the amusement facility and information indicating that the user uses a ride with the certain running speed or lower, i.e., a ride mainly intended for a viewing experience.

The profile information of the user includes the age, gender, nationality, and the like of the user. The history of visits to the amusement facility includes the date, the day of the week, the time period, the number of times, and the like that the user has visited the amusement facility.

For example, in a case where the information about the user of the amusement facility is information indicating an article of a character related to the amusement facility or information about a character or a living creature which the user of the amusement facility likes, the event generation unit 111 generates event information corresponding to the character. As one example of the event information corresponding to the character, for example, information indicating an event in which the user can meet the character indicated by the article, information indicating an event in which the user can meet the character that the user likes, and information indicating an event in which the user can meet a character associated with the living creature are considered. Further, as another example of the event information corresponding to the character, information indicating an event in which the user participates in an attraction associated with the character indicated by the article and information indicating an event in which the user is guided to a shop associated with the character indicated by the article are considered. As yet another example of the event information corresponding to the character, information indicating an event in which the user completes a task of collecting articles (character goods) of the character indicated by the article by, for example, purchasing them is considered.

Further, in a case where the information about the user of the amusement facility is a time period during which the user is scheduled to stay in the amusement facility, the event generation unit 111 generates information about events that can be held in the scheduled time period.

Further, in a case where the information about the user of the amusement facility is how the user spend time in the amusement facility, the event generation unit 111 generates event information corresponding to how the user spend time in the amusement facility. For example, if the user spend time using attractions in the amusement facility, the event generation unit 111 can generate information about the attractions, for example, information about the names and the locations of the attractions, as event information. If the user spend time taking a walk in the amusement facility while using only some attractions, the event generation unit 111 can generate a predetermined walking course in the amusement facility as event information.

Further, a case in which the information about the user of the amusement facility is information about an attraction used by the user in the amusement facility will be described. In a case where the information about an attraction used by the user in the amusement facility is information indicating that the user uses a ride with a certain running speed, the event generation unit 111 can generate information about the ride, for example, the name of the ride, as event information. In a case where the information about an attraction used by the user in the amusement facility is information indicating that the user uses a ride with the certain running speed or lower, i.e., a ride mainly intended for a viewing experience, the event generation unit 111 can generate information about the ride with a certain running speed or lower, for example, the name of the ride, as event information.

Further, the event generation unit 111 can generate event information corresponding to the weather of the day on which the user uses the amusement facility. For example, in a case where the weather of the day on which the user uses the amusement facility is rainy, the event generation unit 111 can generate information about indoor attractions, for example, the names and the locations of the indoor attractions, as event information. On the other hand, in a case where the weather of the day on which the user uses the amusement facility is fine, the event generation unit 111 may generate information about outdoor attractions as event information.

Further, the event generation unit 111 can generate event information corresponding to the date on which the user uses the amusement facility. As one example of an event corresponding to the date on which the user uses the amusement facility, for example, an event in which the user dressed in a costume visits photo spots in a case where the above date falls within a specific period before Halloween is considered. As another example of an event corresponding to the date on which the user uses the amusement facility, for example, an event in which the user searches for a specific food or drink sold in the amusement facility, for example, a cake, in a case where the above date falls within a specific period before Christmas is considered. As another example of an event corresponding to the date on which the user uses the amusement facility, for example, an event in which the user visits a facility such as an attraction and a store related to a specific character in a case where the above date is the birthday of the specific character is considered.

Further, the event generation unit 111 can generate event information by using the profile information of the user. For example, the event generation unit 111 can count the number of people by age group and the number of people by gender based on the profile information of the user acquired on the day the user has visited the amusement facility, and generate an event corresponding to each age group and an event corresponding to each gender group. The profile information of the user can be acquired from a database in which the profile information of the user is registered, for example, a database in which the profile information entered by the user using a fan site of the amusement facility is registered. Further, the profile information of the user can be acquired at the time of the user's visit to the amusement facility. In a case where the profile information of the user is acquired at the time of the user's visit to the amusement facility, the event generation unit 111 can use any time after the time at which the number of people are counted, as the start of the event. Further, the event generation unit 111 may determine the number of events to be performed in accordance with the number of people by age group or the number of people by gender.

The event generation unit 111 can generate event information by using a trained model such as Artificial Intelligence (AI) that is trained by machine learning such as deep learning. The event generation unit 111 can train the model by using training data in which information about the user of the amusement facility is used as input information and event information associated with the information about the user of the amusement facility is used as output information. Further, the event generation unit 111 can train the model by using training data in which the weather of the day on which the user uses the amusement facility is used as input information and event information associated with the above weather is used as output information. Furthermore, the event generation unit 111 can train the model by using training data in which the date on which the user uses the amusement facility is used as input information and event information associated with the above date is used as output information.

The map information generation unit 112 generates map information including information about the location of the event indicated by event information generated by the event generation unit 111. Specifically, the map information generation unit 112 can generate, by using map information in the amusement facility and information about the location of the event, map information including the information about the location of the event.

The article specification unit 113 specifies an article corresponding to an answer of the user to a questionnaire related to event information generated by the event generation unit 111. FIG. 8 shows an example of the questionnaire related to the event information. The items of the questionnaire include, for example, a living creature which the user likes, the number of times the user visits the amusement facility, and the age of the user. Note that the items of the questionnaire are not limited to the above pieces of information. The user terminal apparatus 20 can display the questionnaire on a display unit 24. The user terminal apparatus 20 transmits information indicating the answers of the questionnaire entered or selected by the user to the information processing apparatus 10.

The article specification unit 113 specifies an article corresponding to the answer of the user by using the information indicating the answers of the questionnaire transmitted by the user terminal apparatus 20. For example, in a case where the answer of the user regarding a living creature which the user likes is a cat, the article specification unit 113 can specify an article associated with a cat, for example, cat character goods.

Further, the article specification unit 113 can specify an article corresponding to the number of visits made by the user to the amusement facility. For example, the article specification unit 113 can specify an article which is more popular with the user as the number of times the user has visited the amusement facility is smaller.

Further, the article specification unit 113 can specify an article corresponding to the age of the user of the amusement facility. For example, in a case where the user is between one and ten years old, the article specification unit 113 can specify an article which the user in this age group prefers, for example, a toy.

In a case where the questionnaire includes a plurality of questions, the article specification unit 113 can specify, based on a predetermined order of priority for the plurality of questions, an article corresponding to the answer to a high-priority question.

The registration unit 114 associates identification information of the article specified by the article specification unit 113 and a point that can be used to purchase an article sold by the amusement facility with identification information of the user who has participated in the event that is indicated by the event information generated by the event generation unit 111 and registers the associated information in a user information table. FIG. 4 is a diagram showing an example of the user information table. The user information table is stored in the storage apparatus 13 of the information processing apparatus 10. The point that can be used by the user to purchase an article sold by the amusement facility and the identification information of the article (an article ID) are associated with the identification information of the user (a user ID) and registered in the user information table.

The transmission unit 115 transmits various types of information to the user terminal apparatus 20 and the facility-side terminal apparatus 30.

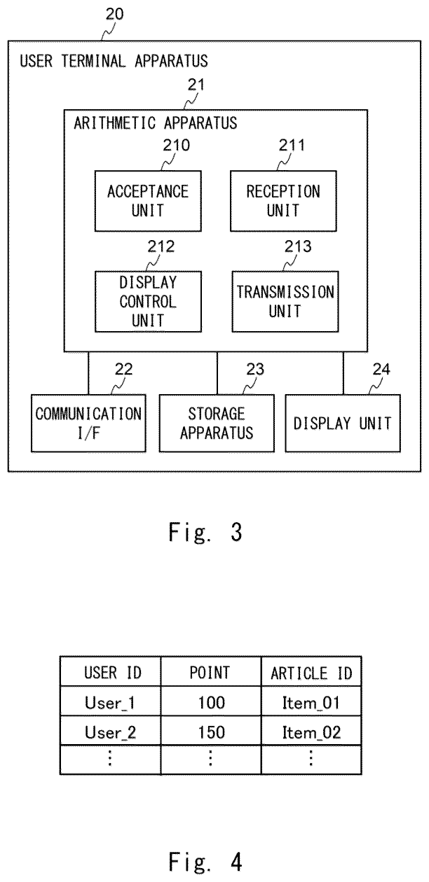

FIG. 3 is a schematic diagram showing the configuration of the user terminal apparatus 20 according to the present disclosure. The user terminal apparatus 20 includes an arithmetic apparatus 21, a communication interface 22, a storage apparatus 23, and the display unit 24.

The arithmetic apparatus 21 is an apparatus that performs overall control of the user terminal apparatus 20. Specific examples of the arithmetic apparatus 21 include a processor such as a CPU or an MPU. The arithmetic apparatus 21 loads a program stored in the storage apparatus 23 into a memory and executes instructions included in the loaded program. Note that, in another example embodiment, functions executed by the arithmetic apparatus 21 may also be executed by an integrated circuit such as an FPGA or an ASIC. Each of these apparatuses corresponds to a computer.

The communication interface 22 is an interface for performing data communication between the user terminal apparatus 20 and another apparatus. The storage apparatus 23 is a storage device in which various type of data such as a program executed by the arithmetic apparatus 21 and data processed by the arithmetic apparatus 21 are stored. The display unit 24 is an apparatus, such as a display, which displays various images.

The arithmetic apparatus 21 includes an acceptance unit 210, a reception unit 211, a display control unit 212, and a transmission unit 213. These functional units may be implemented by a program.

The acceptance unit 210 accepts information required to generate an event and an answer of a user to a questionnaire.

The reception unit 211 receives various types of information transmitted by the information processing apparatus 10, such as event information, map information, and questionnaire information.

The display control unit 212 displays various types of information on the display unit 24. Specifically, the display control unit 212 displays a questionnaire for a user who has participated in an event on the display unit 24. The display control unit 212 also displays information transmitted by the information processing apparatus 10, such as the event information and the map information, on the display unit 24. The display control unit 212 corresponds to an output unit that outputs information transmitted by the information processing apparatus 10. In another example embodiment, the user terminal apparatus 20 may output information transmitted by the information processing apparatus 10 by voice.

The transmission unit 213 transmits various types of information, such as the information required to generate an event and the answer to the questionnaire, to the information processing apparatus 10.

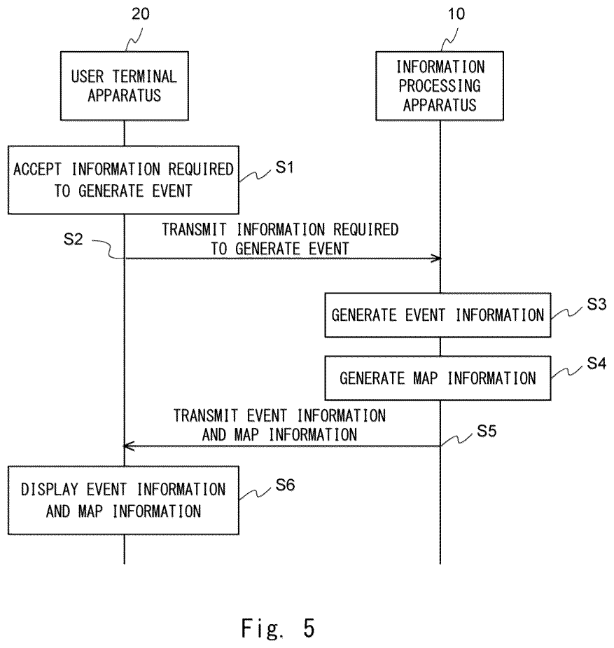

FIG. 5 is a sequence diagram showing an example of processes executed in the information processing system 1. In Step S1, the acceptance unit 210 of the user terminal apparatus 20 accepts information required to generate an event. In Step S2, the transmission unit 213 of the user terminal apparatus 20 transmits the accepted information required to generate the event to the information processing apparatus 10.

If the reception unit 110 of the information processing apparatus 10 receives the information required to generate the event transmitted by the information processing apparatus 10, the event generation unit 111 of the information processing apparatus 10 generates event information corresponding to the received information required to generate the event in Step S3. In Step S4, the map information generation unit 112 of the information processing apparatus 10 generates map information indicating the location where the event is held by using the event information generated by the event generation unit 111 and map information of the amusement facility. In Step S5, the transmission unit 115 of the information processing apparatus 10 transmits the event information and the map information indicating the location where the event is held to the user terminal apparatus 20.

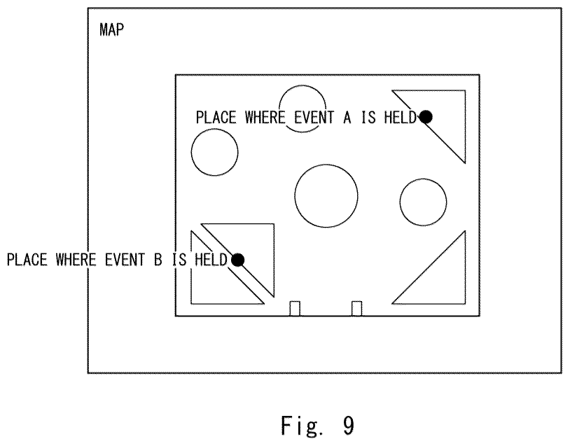

If the reception unit 211 of the user terminal apparatus 20 receives the event information and the map information transmitted by the information processing apparatus 10, the display control unit 212 displays the received event information and map information on the display unit 24 of the user terminal apparatus 20. FIG. 9 shows an example of an image including the event information and the map information. The map information includes a plan view showing the positions of structures such as buildings in the amusement facility. Note that the image displayed on the display unit 24 may include various types of map information and event information.

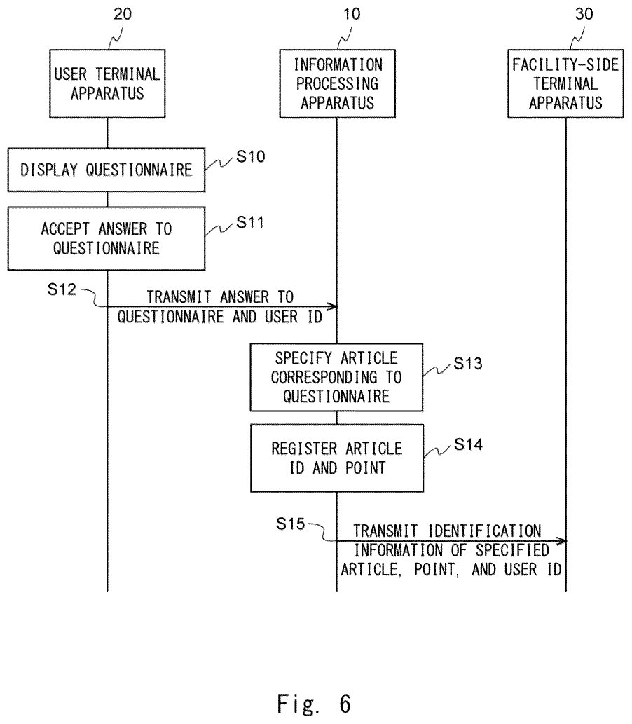

FIG. 6 is a sequence diagram showing another example of processes executed in the information processing system 1. In Step S10, the display control unit 212 of the user terminal apparatus 20 displays, on the display unit 24 of the user terminal apparatus 20, the questionnaire to be conducted with participants in the event generated by the event generation unit 111. In Step S11, the acceptance unit 210 of the user terminal apparatus 20 accepts the answer of the user to the questionnaire. In Step S12, the transmission unit 213 of the user terminal apparatus 20 transmits the answer of the user to the questionnaire and identification information of the user (a user ID) to the information processing apparatus 10.

In Step S13, the article specification unit 113 of the information processing apparatus 10 specifies an article corresponding to the answer of the user to the questionnaire transmitted by the user terminal apparatus 20. In Step S14, the registration unit 114 of the information processing apparatus 10 associates identification information of the article (an article ID) specified by the article specification unit 113 and a point corresponding to the event indicated by the event information with the user ID and registers them in the user information table.

In Step S15, the transmission unit 115 of the information processing apparatus 10 transmits the identification information of the specified article and the identification information of the user to the facility-side terminal apparatus 30. In another example embodiment, the transmission unit 115 of the information processing apparatus 10 may further transmit the identification information of the specified article to the user terminal apparatus 20.

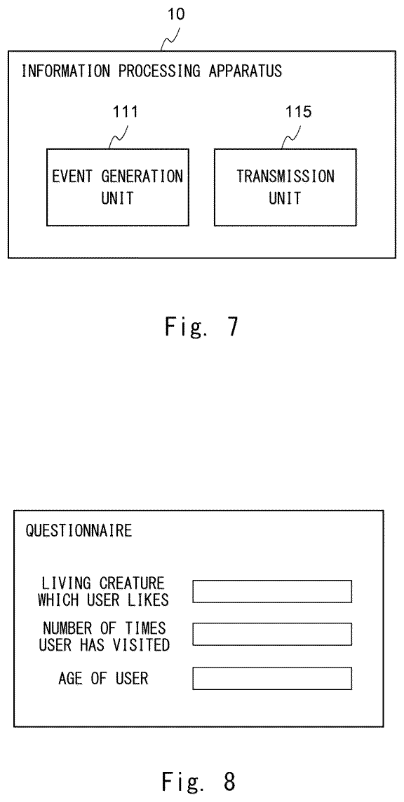

FIG. 7 is a diagram showing main components included in the information processing apparatus 10. The information processing apparatus 10 includes the event generation unit 111 and the transmission unit 115. The event generation unit 111 generates event information about an event performed in an amusement facility corresponding to information about a user of the amusement facility. The transmission unit 115 transmits the event information generated by the event generation unit 111. The information about the user of the amusement facility includes at least one of information indicating an article of a character related to the amusement facility, a time period during which the user is scheduled to stay in the amusement facility, how the user spend time in the amusement facility, and information about an attraction used by the user in the amusement facility. By adopting the above configuration, the information about the event performed in the amusement facility can be generated based on the information about the user of the amusement facility.

Further, in the above-described example embodiment, the event generation unit 111 generates event information corresponding to at least one of the weather of the day on which the user uses the amusement facility and the date on which the user uses the amusement facility. Thus, information about the event corresponding to the weather of the day on which the user uses the amusement facility and/or the date on which the user uses the amusement facility can be generated.

Further, in the above-described example embodiment, the article specification unit 113 specifies an article corresponding to the answer of the user to the questionnaire related to the event information generated by the event generation unit 111. Then the transmission unit 115 transmits information about the article specified by the article specification unit 113. Thus, information about the article corresponding to the answer of the user to the questionnaire can be provided.

Further, in the above-described example embodiment, the registration unit 114 associates a point that can be used to purchase an article sold by the amusement facility with identification information of the user who has participated in the event that is indicated by the event information generated by the event generation unit 111 and registers them. Thus, the point that can be used to purchase an article sold by the amusement facility can be given to the user who has participated in the event indicated by the event information.

Further, in the above-described example embodiment, the map information generation unit 112 generates map information including information about the location of the event that is indicated by the event information generated by the event generation unit 111. Then the transmission unit 115 transmits the map information generated by the map information generation unit 112. Thus, the map information including the information about the location of the event that is indicated by the event information generated by the event generation unit 111 can be provided.

In the example described above, the program includes instructions (or software codes) that, in a case where it is loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A method, wherein
a computer generates event information about an event performed in an amusement facility, the event corresponding to information about a user of the amusement facility,
the computer transmits the generated event information, and
the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

### (Supplementary Note 2)

The method according to supplementary note 1, wherein the computer generates the event information corresponding to at least one of weather of a day on which the user uses the amusement facility and a date on which the user uses the amusement facility.

### (Supplementary Note 3)

The method according to supplementary note 1, wherein
the computer specifies an article corresponding to an answer of the user to a questionnaire related to the generated event information, and
the computer transmits information about the specified article.

### (Supplementary Note 4)

The method according to supplementary note 1, wherein the computer associates a point that can be used to purchase an article sold by the amusement facility with identification information of the user who has participated in the event indicated by the generated event information and registers the associated information.

### (Supplementary Note 5)

The method according to supplementary note 1, wherein
the computer generates map information including information about a location of the event indicated by the generated event information, and
the computer transmits the generated map information.

### (Supplementary Note 6)

An information processing apparatus configured to provide information about an amusement facility, the information processing apparatus comprising:
at least one memory storing instructions; and
at least one processor executing the instructions to:
   generate event information about an event performed in the amusement facility, the event corresponding to information about a user of the amusement facility; and
   transmit the generated event information,
wherein the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

### (Supplementary Note 7)

The information processing apparatus according to supplementary note 6, wherein the at least one processor executes the instructions to generate the event information corresponding to at least one of weather of a day on which the user uses the amusement facility and a date on which the user uses the amusement facility.

### (Supplementary Note 8)

The information processing apparatus according to supplementary note 6, wherein the at least one processor executes the instructions to:
specify an article corresponding to an answer of the user to a questionnaire related to the generated event information; and
transmit information about the specified article.

### (Supplementary Note 9)

The information processing apparatus according to supplementary note 6, wherein the at least one processor executes the instructions to associate a point that can be used to purchase an article sold by the amusement facility with identification information of the user who has participated in the event indicated by the generated event information and register the associated information.

### (Supplementary Note 10)

The information processing apparatus according to supplementary note 6, wherein the at least one processor executes the instructions to:
generate map information including information about a location of the event indicated by the generated event information; and
transmit the generated map information.

### (Supplementary Note 11)

A non-transitory storage medium storing a program for causing a computer to:
generate event information about an event performed in an amusement facility, the event corresponding to information about a user of the amusement facility; and
transmit the generated event information,
wherein the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

### (Supplementary Note 12)

The non-transitory storage medium according to supplementary note 11, wherein the program causes the computer to generate the event information corresponding to at least one of weather of a day on which the user uses the amusement facility and a date on which the user uses the amusement facility.

### (Supplementary Note 13)

The non-transitory storage medium according to supplementary note 11, wherein the program causes the computer to:
specify an article corresponding to an answer of the user to a questionnaire related to the generated event information; and
transmit information about the specified article.

### (Supplementary Note 14)

The non-transitory storage medium according to supplementary note 11, wherein the program causes the computer to associate a point that can be used to purchase an article sold by the amusement facility with identification information of the user who has participated in the event indicated by the generated event information and register the associated information.

### (Supplementary Note 15)

The non-transitory storage medium according to supplementary note 11, wherein the program causes the computer to:
generate map information including information about a location of the event indicated by the generated event information; and
transmit the generated map information.

### (Supplementary Note 16)

An information processing system comprising:
a terminal apparatus used by a user of an amusement facility; and
an information processing apparatus configured to provide information about the amusement facility, wherein
the terminal apparatus comprises:
   a transmission unit configured to transmit information about the user of the amusement facility to the information processing apparatus; and
   an output unit configured to output information transmitted by the information processing apparatus,
the information processing apparatus comprises:
   an event generation unit configured to generate event information about an event performed in the amusement facility, the event corresponding to the information about the user of the amusement facility; and
   a transmission unit configured to transmit the event information generated by the event generation unit to the terminal apparatus, and
the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

Some or all of elements specified in supplementary notes 7 to 10 dependent on supplementary note 6 may also be dependent on supplementary note 16 in dependency similar to that of supplementary notes 7 to 10 on supplementary note 1. Some or all of elements specified in any of supplementary notes may be applied to various types of hardware, software, and recording means for recording software, systems, and methods.

What is claimed is:

1. A method, wherein
a computer generates event information about an event performed in an amusement facility, the event corresponding to information about a user of the amusement facility,
the computer transmits the generated event information, and
the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

2. The method according to claim 1, wherein the computer generates the event information corresponding to at least one of weather of a day on which the user uses the amusement facility and a date on which the user uses the amusement facility.

3. The method according to claim 1, wherein
the computer specifies an article corresponding to an answer of the user to a questionnaire related to the generated event information, and
the computer transmits information about the specified article.

4. The method according to claim 1, wherein the computer associates a point that can be used to purchase an article sold by the amusement facility with identification information of the user who has participated in the event indicated by the generated event information and registers the associated information.

5. The method according to claim 1, wherein
the computer generates map information including information about a location of the event indicated by the generated event information, and
the computer transmits the generated map information.

6. An information processing apparatus configured to provide information about an amusement facility, the information processing apparatus comprising:
at least one memory storing instructions; and
at least one processor executing the instructions to:
generate event information about an event performed in the amusement facility, the event corresponding to information about a user of the amusement facility; and
transmit the generated event information,
wherein the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

7. The information processing apparatus according to claim 6, wherein the at least one processor executes the instructions to generate the event information corresponding to at least one of weather of a day on which the user uses the amusement facility and a date on which the user uses the amusement facility.

8. The information processing apparatus according to claim 6, wherein the at least one processor executes the instructions to:
specify an article corresponding to an answer of the user to a questionnaire related to the generated event information; and
transmit information about the specified article.

9. The information processing apparatus according to claim 6, wherein the at least one processor executes the instructions to associate a point that can be used to purchase an article sold by the amusement facility with identification information of the user who has participated in the event indicated by the generated event information and register the associated information.

10. The information processing apparatus according to claim 6, wherein the at least one processor executes the instructions to:
generate map information including information about a location of the event indicated by the generated event information; and
transmit the generated map information.

11. A non-transitory storage medium storing a program for causing a computer to:
generate event information about an event performed in an amusement facility, the event corresponding to information about a user of the amusement facility; and
transmit the generated event information,
wherein the information about the user of the amusement facility includes at least one of information indicating an article of a character related to the amusement facility, information about a character or a living creature which the user likes, a time period during which the user is scheduled to stay in the amusement facility, how the user spend time in the amusement facility, information about an attraction used by the user in the amusement facility, profile information of the user, and a history of visits made by the user to the amusement facility.

12. The non-transitory storage medium according to claim 11, wherein the program causes the computer to generate the event information corresponding to at least one of weather of a day on which the user uses the amusement facility and a date on which the user uses the amusement facility.

13. The non-transitory storage medium according to claim 11, wherein the program causes the computer to:
specify an article corresponding to an answer of the user to a questionnaire related to the generated event information; and
transmit information about the specified article.

14. The non-transitory storage medium according to claim 11, wherein the program causes the computer to associate a point that can be used to purchase an article sold by the amusement facility with identification information of the user who has participated in the event indicated by the generated event information and register the associated information.

15. The non-transitory storage medium according to claim 11, wherein the program causes the computer to:
generate map information including information about a location of the event indicated by the generated event information; and
transmit the generated map information.
